(19) United States
(12) Patent Application Publication
(10) Pub. No.: US 2014/0155063 A1
(43) Pub. Date: Jun. 5, 2014

(54) WIRELESS COMMUNICATION SYSTEM AND BASE STATION DEVICE

(71) Applicant: Yasuo Koide, Kanagawa (JP)

(72) Inventor: Yasuo Koide, Kanagawa (JP)

(73) Assignee: Panasonic Corporation, Osaka (JP)

(21) Appl. No.: 14/236,008

(22) PCT Filed: Jul. 31, 2012
(86) PCT No.: PCT/JP2012/004847

§ 371 Date: Jan. 29, 2014

(30) Foreign Application Priority Data
Sep. 30, 2011 (JP) 2011-217418

(51) Int. Cl. H04W 48/16

(52) U.S. Cl. CPC H04W 48/16
USPC 455/434

(57) ABSTRACT

Provided are a wireless communication system and a base station device. An entrance cell base station (100) acquires a UE identifier from a UE that has accessed an entrance cell, whereupon a management server (200) manages the acquired UE identifier together with a period of validity if the UE identifier that has been acquired from the entrance cell base station (100) has been newly added, and if the acquired UE identifier is already being managed, deletes the managed identifier, and reports the modified content to a limit cell group base station (300). When the UE accesses the limit cell group, the limit cell group base station (300) acquires the UE identifier from the UE in order to either allow or deny access to the limit cell group in accordance with whether or not there is a match with a valid UE identifier reported from the management server (200).

### TECHNICAL FIELD

The present invention relates to a radio communication system and a base station apparatus that allow or restrict access to a specific cell from a terminal.

### BACKGROUND ART

In recent years, development of small-cell base stations called “HeNB (Home eNode B)” or “femto base stations” is underway aiming at complementing a dead zone or at improving throughput in indoor areas of communication using mobile phones.

HeNB or femto base stations are supposed to be used in homes, companies, shopping malls and the like. Cells provided by HeNB or femto base stations installed in homes, companies, shopping malls or the like are each supposed to be used as a way to provide a service only for specific terminals (hereinafter, referred to as “User Equipment (UE)”). For example, such an HeNB or femto base station may be made available to only family members in the home, only employees in the company and only registered users in the shopping mall.

3GPP (3rd Generation Partnership Project) defines three cell access modes including closed, hybrid and open access modes. Hereinafter, the three access modes will be described, briefly.

The closed access mode provides a service only to specific members who have access permission (hereinafter, referred to as “CSG (Closed Subscriber Group) member”).

A service in the hybrid access mode is available to CSG members and non-CSG members who have no access permission, but higher priority is given to CSG members than non-CSG members for use of the service.

The open access mode provides a service to all members without any access restriction.

On the premise of these three access modes, a UE receives broadcast information including a CSG ID (identifier for identifying CSG) sent from an eNodeB and can access a CSG cell and a hybrid cell as a CSG member when the received CSG ID is identical to a CSG ID managed in a CSG list of a USIM (universal subscriber identity module).

Furthermore, an MME (mobility management entity) checks whether or not the CSG ID sent by the eNodeB matches the CSG ID included in CSG subscription data which is subscriber information provided by an HSS (home subscriber server) in the operator network, and allows the service by the CSG to be provided, when the CSG IDs match.

Accordingly, in order for the UE to receive a service in the CSG cell or hybrid cell as a CSG member, the two settings below are to be made beforehand. That is, the first one is to register a CSG ID of a cell that the UE desires to access with a CSG list of the USIM and the second one is to register a CSG ID of a cell by which the UE is desired to be served with the CSG subscription data managed by the HSS.

Regarding the first setting above, the CSG list first defines an “allowed CSG list” that can be changed by an operator or UE user, and an “operator CSG list” that can be changed only by an operator. When the allowed CSG list is available to the UEs, the UE users can change the CSG ID registered in the CSG list. When only the operator CSG list is used, the UE user is to ask the operator to change the CSG list in order to change the registered CSG ID. Note that if manually selecting a CSG cell (hereinafter may also be referred to as “manual CSG selection”) is allowed, the UE user can cause the UE to scan available CSG cells and select one of the available CSG cells.

Since the above second setting relates to the information to be managed by an operator apparatus, when changing the CSG ID, the UE user is to ask the operator to change the CSG ID each time.

The procedure for the UE to access a CSG disclosed in NPL 1 will be described based on the above description with reference to FIG. 1. In FIG. 1, in step (hereinafter, abbreviated as “ST”) 11, the UE detects that it has moved to a new tracking area and, in ST12, the UE sends a TAU request (tracking area update request) message to the eNodeB.

In ST13, the eNodeB sends a TAU request message together with the “CSG access mode” and “CSG ID” to a newly selected MME (new MME). The CSG ID is provided when the UE sends the TAU request message via the CSG cell or hybrid cell. Furthermore, when the UE sends the TAU request message via the hybrid cell, the CSG access mode is provided. In the case where the CSG access mode is not provided but the CSG ID is provided, the MME determines the cell as a CSG cell. Note that the “CSG access mode” and “CSG ID” are included in an S1-AP control message that carries a TAU request message.

Here, a description of ST14 to ST26 will be omitted.

In ST27, the HSS sends an update location ACK (update location acknowledgement) including subscription data to the MME. The subscription data also includes CSG subscription data for a PLMN (public land mobile network).

When the UE starts a TAU (tracking area update) procedure in the CSG cell, the MME checks whether or not the CSG ID sent by the eNodeB in ST13 is included in the CSG subscription data and also checks whether or not an effective period of the CSG ID has expired. As a result, when there is no CSG ID sent by the eNodeB in the CSG subscription data or when the effective period of the CSG ID has expired, the MME sends a tracking area update reject including the reason for the rejection to the UE. When the CSG ID is included in the allowed CSG list, the UE deletes the CSG ID from the allowed CSG list. When other check items are successfully verified, the MME creates a context for the UE.

Here, a description of ST28, ST29 and ST31 will be omitted.

In ST30, the UE that has received a tracking area update reject is not allowed to access the TA (tracking area). A TAU procedure is started from the CSG cell by manual CSG selection, and the UE that has received the TAU accept message adds the CSG ID to the allowed CSG list when the CSG ID is not included in the allowed CSG list. Furthermore, a user-plane setup is executed in conjunction with the TAU accept message, and when TAU is performed in the hybrid cell, the MME sends an indication as to whether or not the UE is a CSG member to the eNodeB via an S1-MME control message.

The eNodeB differently treats CSG and non-CSG members based on the information sent from the MME. When the UE receives a TAU accept message via the hybrid cell, the UE does not add the CSG ID to the allowed CSG list. The CSG ID is added to the allowed CSG list for the hybrid cell only using an OTA (over the air) procedure or OMA (open mobile alliance) DM (device management) procedure.

### CITATION LIST

### Non-Patent Literature

### NPL 1

3GPP, TS23.401 V10.3.0 “3rd Generation Partnership Project; Technical Specification Group Services and System Aspects; General Packet Radio Service (GPRS) enhancements for Evolved Universal Terrestrial Radio Access Network (E-UTRAN) access”

### SUMMARY OF INVENTION

### Technical Problem

However, the aforementioned procedure for access to the CSG cell requires that the CSG ID of a cell that a UE desires to access should be registered with a CSG list of the USIM of the UE (allowed CSG list or operator CSG list) and the CSG ID of a cell by which a service is desired to be provided should be registered with CSG subscription data managed by the HSS.

For this reason, when a certain UE is allowed to temporarily use the CSG cell, the following procedure is necessary. That is, the UE user is requested to register the CSG ID of a cell that the UE desires to access with the USIM or requested for manual CSG selection. Furthermore, an administrator of a base station providing a CSG cell that the UE desires to access requests the operator to register the CSG ID of the cell that the UE desires to access with the CSG subscription data managed the by HSS.

These procedures are complicated for an operation to temporarily use the CSG cell. Moreover, the procedure by the operator takes time. For example, when a customer who visits a certain company is to temporarily use an in-company CSG cell, it is not realistic to request the customer to perform a complicated operation. Moreover, in a case where there are many temporary users in a CSG cell such as a shopping mall and CSG IDs are frequently registered or deleted, temporary use according to a conventional procedure using the CSG cell is not realistic in consideration of the work required for the administrator of the base station.

An object of the present invention is to provide a radio communication system and a base station apparatus that easily control whether or not to allow a UE to access a specific cell.

### Solution to Problem

A radio communication system according to an aspect of the present invention is a radio communication system including: a first base station apparatus; a server apparatus; and a second base station apparatus, in which: the first base station apparatus including: a receiving section configured to receive a first message transmitted from a first terminal; an identification information acquiring section configured to acquire identification information for identifying the first terminal from the received first message; and a transmitting section configured to transmit the acquired identification information; the server apparatus including: an identification information receiving section configured to receive the identification information transmitted from the first base station apparatus; an identification information management section configured to add and manage the received identification information together with an effective period, and to delete the identification information under management when the effective period expires; and a sending section configured to send a second message including change contents indicating addition or deletion of the identification information as well as the identification information corresponding to the change contents; and the second base station apparatus including: a message receiving section configured to receive the second message sent by the server apparatus; a receiving section configured to receive a third message transmitted from a second terminal; and an identification information storage section configured to store the identification information corresponding to the change contents according to the change contents included in the second message received from the server apparatus, to compare the stored identification information and identification information included in the third message received from the second terminal, to allow access from the second terminal when the comparison result indicates that the stored identification information matches the identification information included in the third message and to reject access from the second terminal when the comparison result indicates that the stored identification information does not match the identification information included in the third message.

A base station apparatus according to an aspect of the present invention is a base station apparatus including: a receiving section configured to receive a first message transmitted from a first terminal; an identification information acquiring section configured to acquire identification information for identifying the first terminal from the received first message; an identification information management section configured to add and manage the acquired identification information together with an effective period and to delete the identification information under management when the effective period expires; and a sending section configured to send a second message including change contents indicating addition or deletion of the identification information as well as the identification information corresponding to the change contents.

A base station apparatus according to an aspect of the present invention is a base station apparatus including: an identification information receiving section configured to receive identification information for identifying a first terminal from another base station apparatus, the identification information being acquired by the another base station apparatus; an identification information management section configured to add and manage the received identification information together with an effective period and to delete the identification information under management when the effective period expires; a receiving section configured to receive a message transmitted from a second terminal; and an identification information storage section configured to store the identification information corresponding to change contents indicating addition or deletion of the identification information according to the change contents, to compare the stored identification information and identification information included in the message received from the second terminal, to allow access from the second terminal when the comparison result indicates that the stored identification information matches the identification information included in the message received from the second terminal and to reject access from the second terminal when the comparison result indicates that the stored identification information does not match the identification information included in the message received from the second terminal.

### ADVANTAGEOUS EFFECTS OF THE INVENTION

According to the present invention, it is possible to easily control whether or not to allow a UE to access a specific cell.

### BRIEF DESCRIPTION OF THE DRAWINGS

FIG. 1 is a sequence diagram illustrating a procedure for a UE to access a CSG disclosed in NPL 1;

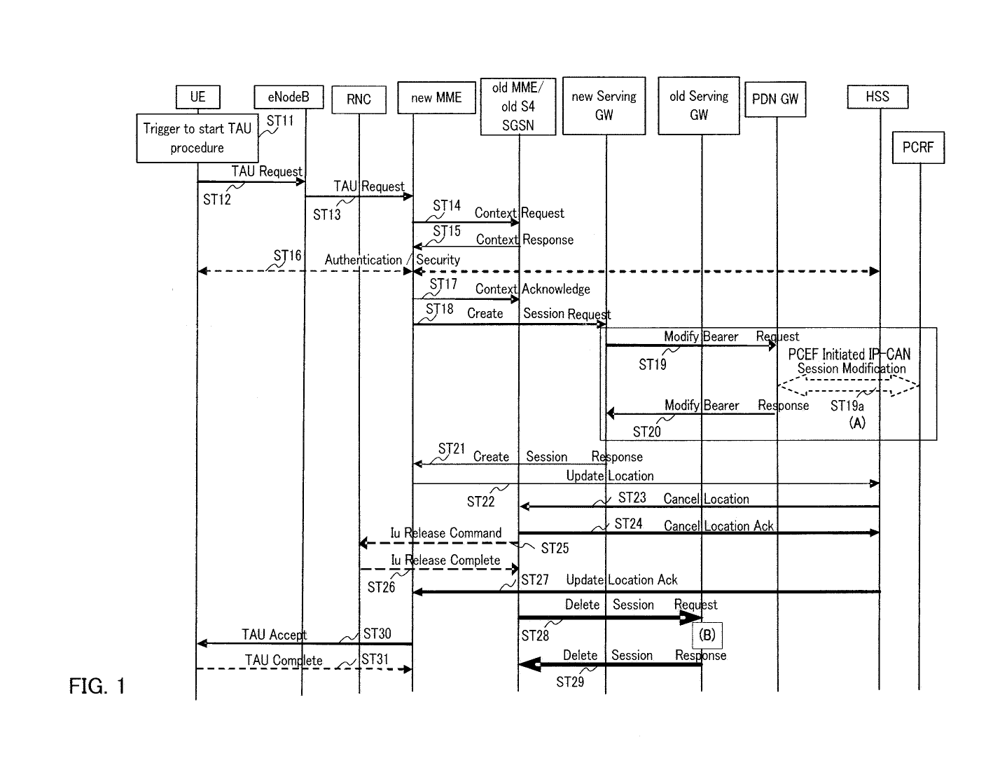

FIG. 2 is a schematic view illustrating an overview of a radio communication system according to an embodiment of the present invention;

FIG. 3 is a block diagram illustrating a configuration of an entrance base station according to the embodiment of the present invention;

FIG. 4 is a block diagram illustrating a configuration of a management server according to the embodiment of the present invention;

FIG. 5 is a block diagram illustrating a configuration of a restricted cell group base station according to the embodiment of the present invention;

FIG. 6 is a sequence diagram illustrating a procedure for setting access permission for a UE to access a restricted cell group base station; and

FIG. 7 is a sequence diagram illustrating a procedure for canceling access permission for the UE to access the restricted cell group base station.

### DESCRIPTION OF EMBODIMENTS

Hereinafter, an embodiment of the present invention will be described in detail with reference to the accompanying drawings.

### Embodiment

In the present embodiment, a new concept called “entrance cell” is provided. The entrance cell is formed by one or a plurality of base stations installed at an entrance such as entry (hereinafter, referred to as “entrance base station”) for a cell in which access to a base station used in a specific area in a company is desired to be restricted (hereinafter, referred to as “restricted cell”) or a group of a plurality of such cells (hereinafter, referred to as “restricted cell group”).

A restricted cell or a restricted cell group is assumed to be an open cell or a hybrid cell defined in 3GPP. It should be noted that when a restricted cell or a restricted cell group is formed of hybrid cells, a non-CSG member UE that makes access to an entrance cell is determined by an MME as a non-CSG member, and therefore such a UE makes access as a non-CSG member with low priority. A CSG member UE makes access as a CSG member, and therefore such a UE is treated with higher priority than a non-CSG member.

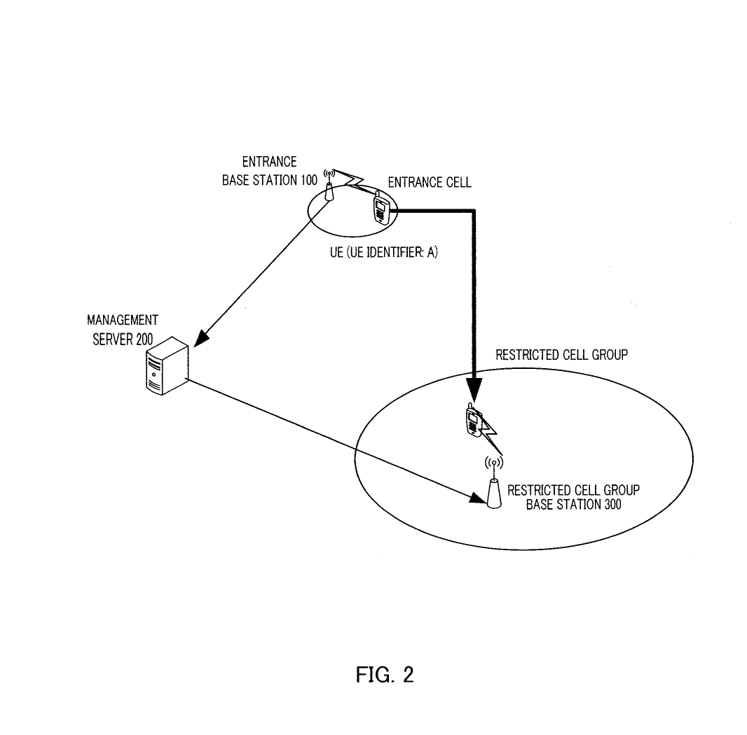

FIG. 2 is a schematic view illustrating an overview of a radio communication system according to an embodiment of the present invention. In FIG. 2, when a UE accesses the entrance cell, entrance base station 100 acquires a verifiable UE identifier included in a message used at the time of access. Examples of the UE identifier include S-TMSI (S-Temporary Mobile Subscriber Identity) included in an RRC message or the like. Entrance base station 100 sends the acquired UE identifier to management server 200.

Entrance base station 100 is provided to acquire a UE identifier of a UE that makes access to entrance base station 100, so entrance base station 100 may be a base station having any shape conforming to a type of usage. For example, entrance base station 100 may be a touch type small-cell base station that allows a UE user to bring the UE into contact with a predetermined area of entrance base station 100 and forms a cell area with very small power. In this case, the small-cell base station may display to indicate that it has acquired the UE identifier, in a manner recognizable by the UE user.

Furthermore, entrance base station 100 may immediately release the connection with the UE from which the UE identifier has been acquired. Alternatively, when all resources of the entrance cell are allocated, the entrance cell may be configured to release the UEs in order from the one with the oldest connection so as to always allow for new connections with high priority. Note that the entrance cell need not have any handover function.

Management server 200 manages UE identifiers sent by entrance base station 100, together with their effective periods. The effective period can be set by an operator. When a UE identifier is “added” or “deleted,” for example, management server 200 sends information indicating that the UE identifier is “added” or “deleted” to the restricted cell and the restricted cell group.

Furthermore, when the UE identifier sent from entrance base station 100 is already under management, this means that the UE having the UE identifier has exited from the entrance cell, and therefore management server 200 deletes the UE identifier.

An administrator of a restricted cell group can optionally delete UE identifiers managed by management server 200 and also optionally set UE identifiers and effective periods in addition to those sent by entrance base station 100.

Note that management server 200 may be provided in the same hardware as that of entrance base station 100 or restricted cell group base station 300.

Restricted cell group base station 300 operates an open cell or hybrid cell as a cell that provides a service and allows only a UE having a UE identifier that matches the UE identifier indicated as “addition” by management server 200 to access the cell.

Furthermore, restricted cell group base station 300 rejects access to the cell from a UE corresponding to a UE identifier indicated as “deletion” from management server 200. Moreover, restricted cell group base station 300 rejects access from a UE that has not accessed the entrance cell.

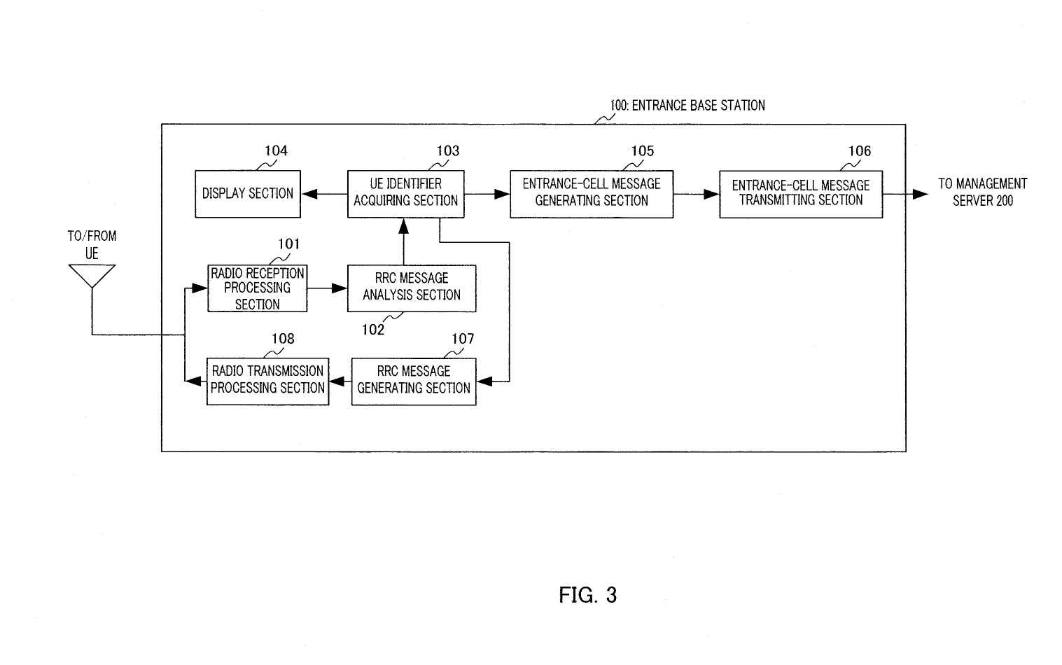

FIG. 3 is a block diagram illustrating a configuration of entrance base station 100 according to the embodiment of the present invention. The configuration of entrance base station 100 will be described hereinafter with reference to FIG. 3.

Radio reception processing section 101 receives an RRC message including a UE identifier transmitted from a UE and outputs the received RRC message to RRC message analysis section 102.

RRC message analysis section 102 analyzes the RRC message outputted from radio reception processing section 101 and acquires a UE identifier (e.g., S-TMSI). The acquired UE identifier is outputted to UE identifier acquiring section 103.

Upon acquiring the UE identifier outputted from RRC message analysis section 102, UE identifier acquiring section 103 sends the UE identifier to display section 104 and entrance-cell message generating section 105. Upon completion of the acquisition of the

UE identifier, UE identifier acquiring section 103 instructs RRC message generating section 107 to release the connection of the UE corresponding to the acquired UE identifier. When all resources of the entrance cell have been allocated, UE identifier acquiring section 103 may issue an instruction to release connection of UEs in order from the one having the oldest connection so as to always allow for new connections with high priority.

Display section 104 displays that a UE identifier has been acquired from UE identifier acquiring section 103.

Entrance-cell message generating section 105 generates a message intended for management server 200 including entrance cell identification information for identifying the entrance cell and the UE identifier outputted from UE identifier acquiring section 103 and outputs the generated message to entrance-cell message transmitting section 106.

Entrance-cell message transmitting section 106 transmits the message outputted from entrance-cell message generating section 105 to management server 200.

RRC message generating section 107 generates an RRC message indicating an instruction to release the connection of the UE instructed from UE identifier acquiring section 103 and outputs the generated RRC message to radio transmission processing section 108.

Radio transmission processing section 108 transmits the RRC message outputted from RRC message generating section 107 to the UE.

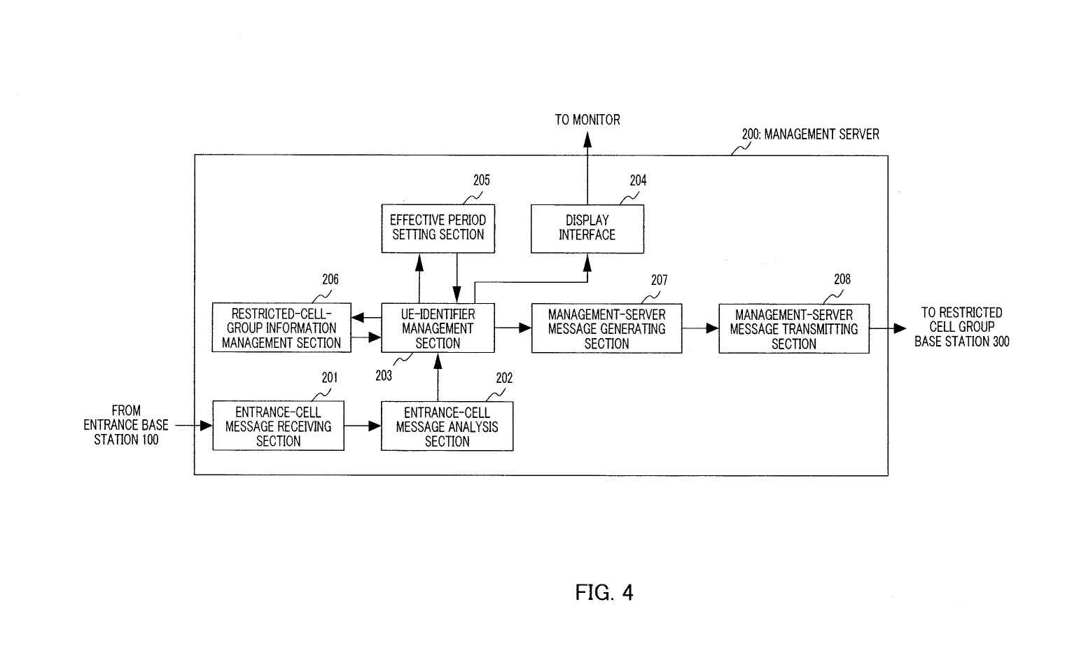

FIG. 4 is a block diagram illustrating a configuration of management server 200 according to the embodiment of the present invention. Hereinafter, the configuration of management server 200 will be described with reference to FIG. 4.

Entrance-cell message receiving section 201 receives an entrance cell message transmitted from entrance base station 100 and outputs the received entrance cell message to entrance-cell message analysis section 202.

Entrance-cell message analysis section 202 analyzes the entrance cell message outputted from entrance-cell message receiving section 201 and acquires entrance cell identification information and a UE identifier from the entrance cell message. The acquired entrance cell identification information and UE identifier are outputted to UE-identifier management section 203.

UE-identifier management section 203 inquires of effective period setting section 205 about the effective period of the UE identifier outputted from entrance-cell message analysis section 202 and manages the UE identifier together with the effective period acquired from effective period setting section 205. When the effective period expires, UE-identifier management section 203 deletes the corresponding UE identifier.

When the UE identifier outputted from entrance-cell message analysis section 202 is already under management, UE-identifier management section 203 deletes the UE identifier under management.

UE-identifier management section 203 sends the entrance cell identification information acquired from entrance-cell message analysis section 202 restricted-cell-group information management section 206 and acquires a restricted cell group corresponding to the entrance cell from restricted-cell-group information management section 206.

When information under its management is changed, UE-identifier management section 203 sends the change contents, UE identifier and restricted cell group to management-server message generating section 207.

Furthermore, UE-identifier management section 203 sends the UE identifier, effective period and restricted cell group to display interface 204.

Display interface 204 converts the UE identifier, effective period and restricted cell group sent by UE-identifier management section 203 to signals to be displayed on a monitor.

Effective period setting section 205 sends the effective period of the UE identifier to UE-identifier management section 203 based on the inquiry from UE-identifier management section 203.

Restricted-cell-group information management section 206 manages information on a restricted cell group to which a service can be provided, in association with the entrance cell, and sends the restricted cell group corresponding to the corresponding entrance cell identification information to UE-identifier management section 203 in response to the inquiry from UE-identifier management section 203.

Management-server message generating section 207 generates a management server message directed to a restricted cell group including the change contents and UE identifier sent by UE-identifier management section 203 and outputs the generated management server message to management-server message transmitting section 208.

Management-server message transmitting section 208 transmits the management server message outputted from management-server message generating section 207 to restricted cell group base station 300.

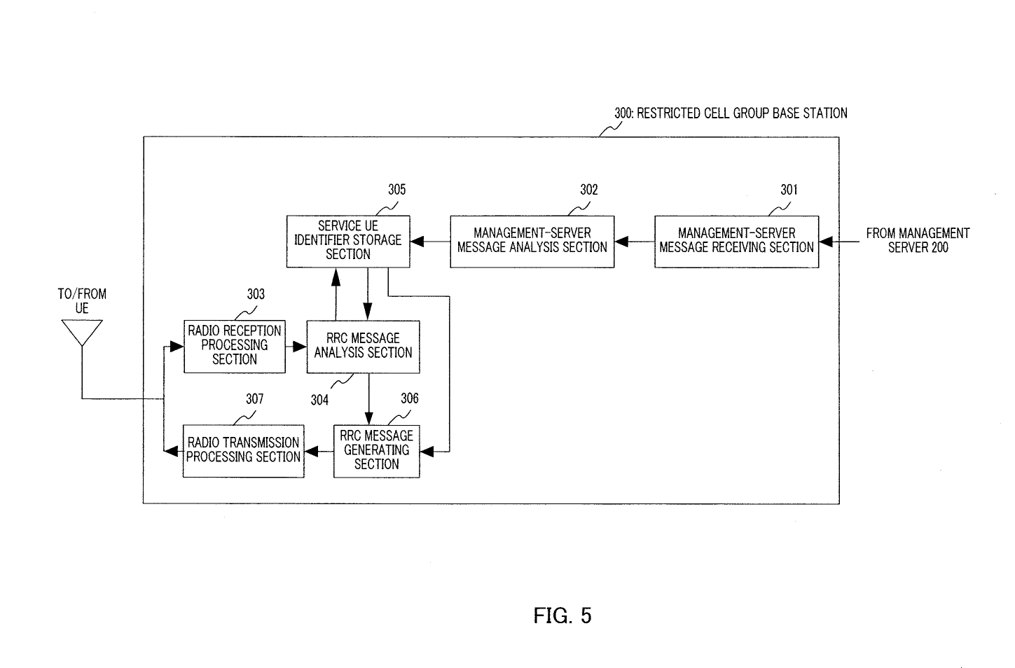

FIG. 5 is a block diagram illustrating a configuration of restricted cell group base station 300 according to the embodiment of the present invention. Hereinafter, the configuration of restricted cell group base station 300 will be described with reference to FIG. 5.

Management-server message receiving section 301 receives a management server message transmitted from management server 200 and outputs the received management server message to management-server message analysis section 302.

Management-server message analysis section 302 analyzes the management server message outputted from management-server message receiving section 301, acquires the change contents and the UE identifier, and outputs the acquired information to service UE identifier storage section 305.

Radio reception processing section 303 receives an RRC message transmitted from the UE and outputs the received RRC message to RRC message analysis section 304.

RRC message analysis section 304 analyzes the RRC message outputted from radio reception processing section 303 and acquires a UE identifier from the RRC message. RRC message analysis section 304 sends the acquired UE identifier to service UE identifier storage section 305 and checks whether matching stored information exists or not. When matching information exists, RRC message analysis section 304 sends an instruction to allow access from the corresponding UE to RRC message generating section 306, and when no matching information exists, RRC message analysis section 304 sends an instruction for rejecting access from the corresponding UE to RRC message generating section 306.

Service UE identifier storage section 305 updates the stored information therein based on the change contents and the UE identifier outputted from management-server message analysis section 302. More specifically, service UE identifier storage section 305 adds the stored information when the change contents are “addition,” or deletes the information stored corresponding to the sent UE identifier when the change contents are “deletion.” At this time, if the UE corresponding to the deleted UE identifier is connected, service UE identifier storage section 305 sends an instruction to release the connection to RRC message generating section 306.

Service UE identifier storage section 305 compares the UE identifier sent from RRC message analysis section 304 and the stored information, and checks whether matching information exists or not. When matching information exists, service UE identifier storage section 305 sends the match to RRC message analysis section 304 and when no matching information exists, service UE identifier storage section 305 sends a mismatch to RRC message analysis section 304.

RRC message generating section 306 generates an RRC message according to the instructions from RRC message analysis section 304 and service UE identifier storage section 305 and outputs the generated RRC message to radio transmission processing section 307.

Radio transmission processing section 307 transmits the RRC message outputted from RRC message generating section 306 to the UE.

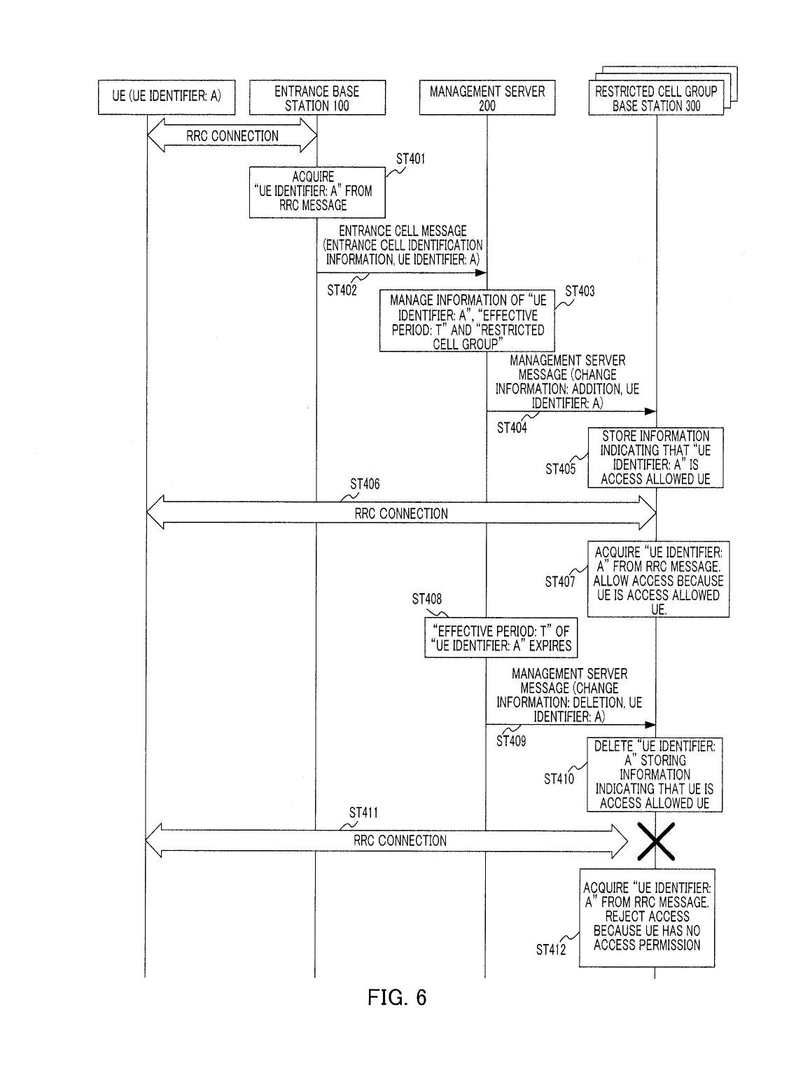

Next, a procedure for setting access permission for the UE to restricted cell group base station 300 will be described with reference to FIG. 6. In FIG. 6, in ST401, entrance base station 100 acquires “UE identifier: A” from the RRC message when an RRC connection with the UE is established.

In ST402, entrance base station 100 transmits an entrance cell message including entrance cell identification information and the “UE identifier: A” acquired in ST401 to management server 200, and in ST403, management server 200 manages the information on “UE identifier: A,” and “effective period: T” and the restricted cell group thereof based on the received entrance cell message.

In ST404, management server 200 transmits a management server message including “changed information: addition” and the “UE identifier: A” to restricted cell group base station 300 associated with the entrance cell identification information, and in ST405, restricted cell group base station 300 stores information indicating that the UE with the “UE identifier: A” is an access allowed UE.

In ST406, the UE with “UE identifier: A” accesses restricted cell group base station 300, and in ST407, since restricted cell group base station 300 stores information indicating that the UE with the “UE identifier: A” is an access allowed UE, restricted cell group base station 300 allows establishment of an RRC connection of this UE.

In ST408, the effective period of “UE identifier: A” expires, and in ST409, management server 200 transmits a management server message including “changed information: deletion” and “UE identifier: A” to restricted cell group base station 300 associated with entrance cell identification information, and in ST410, restricted cell group base station 300 deletes the “UE identifier: A” which stores information as the access allowed UE.

In ST411, the UE with the “UE identifier: A” accesses restricted cell group base station 300, and in ST412, since the “UE identifier: A” indicates that the UE is a UE without access permission, restricted cell group base station 300 does not allow this UE to establish an RRC connection.

Thus, only UEs whose UE identifiers have been acquired by entrance base station 100, that is, UEs that have passed through the entrance cell and fall within a predetermined range of time after passing through the entrance cell (effective period) are allowed to access the restricted cell group.

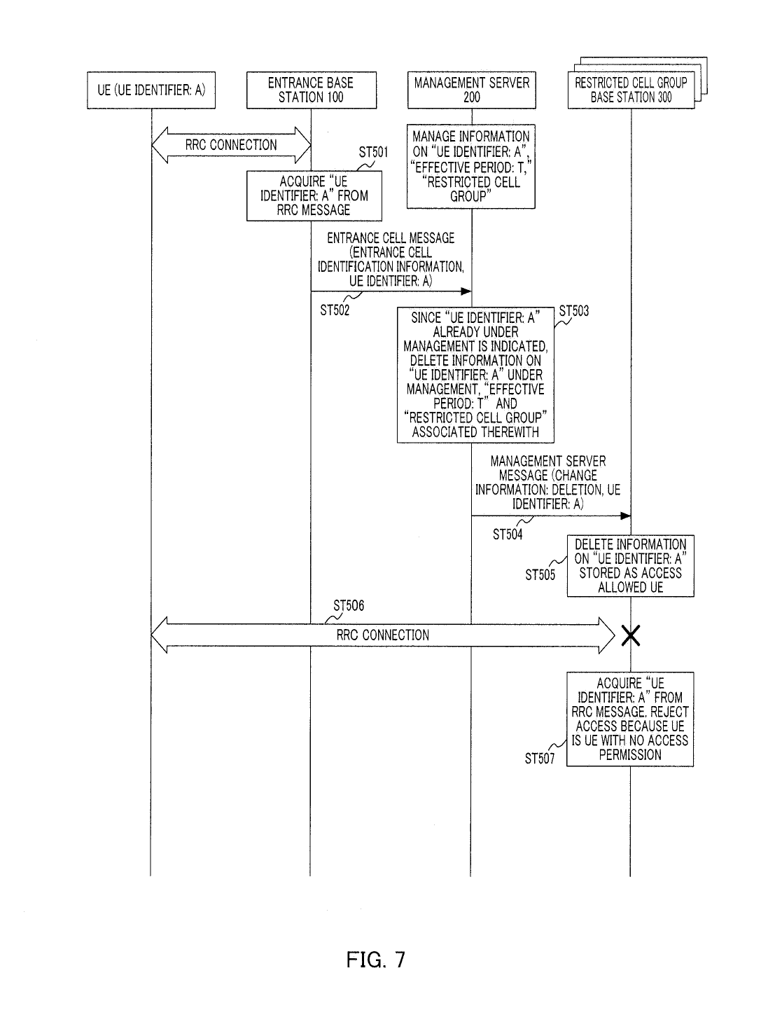

Next, a procedure for setting cancellation of access permission for a UE to restricted cell group base station 300 will be described with reference to FIG. 7. In FIG. 7, in ST501, entrance base station 100 acquires “UE identifier: A” from the RRC message when an RRC connection with the UE is established.

In ST502, entrance base station 100 transmits an entrance cell message including entrance cell identification information and the “UE identifier: A” acquired in ST501 to management server 200, and in ST503, since the “UE identifier: A” included in the received entrance cell message is the identifier already under its management, management server 200 deletes the information on “UE identifier: A,” and “effective period: T” and the “restricted cell group” associated therewith from the information under its management.

In ST504, management server 200 transmits a management server message including “changed information: deletion” and “UE identifier: A” to restricted cell group base station 300, and in ST505, restricted cell group base station 300 deletes the “UE identifier: A” stored as the access allowed UE.

In ST506, the UE with “UE identifier: A” accesses restricted cell group base station 300, and since the “UE identifier: A” indicates that the UE is a UE without access permission, in ST507, restricted cell group base station 300 does not allow the UE to establish an RRC connection.

Thus, according to the present embodiment, it is possible to acquire a UE identifier from a UE that accesses an entrance cell, manage the acquired UE identifier if it is newly added together with an effective period, delete the UE identifier if the acquired

UE identifier is already under management, acquire, when the UE accesses a restricted cell group, the UE identifier from the UE in the restricted cell group, allow or reject access by the UE to the restricted cell group depending on whether or not the UE identifier matches a valid UE identifier under management, and thereby easily control whether or not to allow the UE to access a specific cell.

As a result, it is possible to omit changes in setting of a USIM and an operator network apparatus necessary for access permission in a closed access mode, and thereby to control cell access from a UE easily in a short time.

The disclosure of Japanese Patent Application No. 2011-217418, filed on Sep. 30, 2011, including the specification, drawings and abstract is incorporated herein by reference in its entirety.

### INDUSTRIAL APPLICABILITY

The radio communication system and the base station apparatus according to the present invention are suitable for use in easily controlling access permission for a UE to a specific cell or cancellation of the access permission.

### REFERENCE SIGN LIST

100 Entrance base station
101, 303 Radio reception processing section
102, 304 RRC message analysis section
103 UE identifier acquiring section
104 Display section
105 Entrance-cell message generating section
106 Entrance-cell message transmitting section
107, 306 RRC message generating section
108, 307 Radio transmission processing section
200 Management server
201 Entrance-cell message receiving section
202 Entrance-cell message analysis section
203 UE-identifier management section
204 Display interface
205 Effective period setting section
206 Restricted-cell-group information management section
207 Management-server message generating section
208 Management-server message transmitting section
300 Restricted cell group base station
301 Management-server message receiving section
302 Management-server message analysis section
305 Service UE identifier storage section

1. A radio communication system comprising:
a first base station apparatus;
a server apparatus; and
a second base station apparatus, wherein:
the first base station apparatus comprising:
a receiving section configured to receive a first message transmitted from a first terminal;
an identification information acquiring section configured to acquire identification information for identifying the first terminal from the received first message; and
a transmitting section configured to transmit the acquired identification information;
the server apparatus comprising:
an identification information receiving section configured to receive the identification information transmitted from the first base station apparatus;
an identification information management section configured to add and manage the received identification information together with an effective period, and to delete the identification information under management when the effective period expires; and
a sending section configured to send a second message including change contents indicating addition or deletion of the identification information as well as the identification information corresponding to the change contents; and
the second base station apparatus comprising:
a message receiving section configured to receive the second message sent by the server apparatus;
a receiving section configured to receive a third message transmitted from a second terminal; and
an identification information storage section configured to store the identification information corresponding to the change contents according to the change contents included in the second message received from the server apparatus, to compare the stored identification information and identification information included in the third message received from the second terminal, to allow access from the second terminal when the comparison result indicates that the stored identification information matches the identification information included in the third message and to reject access from the second terminal when the comparison result indicates that the stored identification information does not match the identification information included in the third message.

2. A base station apparatus comprising:
a receiving section configured to receive a first message transmitted from a first terminal;
an identification information acquiring section configured to acquire identification information for identifying the first terminal from the received first message;
an identification information management section configured to add and manage the acquired identification information together with an effective period and to delete the identification information under management when the effective period expires; and
a sending section configured to send a second message including change contents indicating addition or deletion of the identification information as well as the identification information corresponding to the change contents.

3. The base station apparatus according to claim 2, further comprising a display section configured to display that acquisition of the identification information is completed.

4. The base station apparatus according to claim 2, wherein, the identification information acquiring section is configured to, when the acquisition of the identification information is completed, issue an instruction to release connection of the terminal corresponding to the identification information.

5. The base station apparatus according to claim 2, wherein, the identification information acquiring section is configured to, when all resources to be used for connection with the terminal are allocated, issue an instruction to release connection of terminals in order from a terminal corresponding to the oldest connection.

6. The base station apparatus according to claim 2, wherein, the identification information management section is configured to, when the received identification information is already under management, delete the identification information under management.

7. The base station apparatus according to claim 6, wherein the sending section is configured to send the second message including change contents indicating deletion of the identification information as well as the identification information corresponding to the deletion.

8. A base station apparatus comprising:
an identification information receiving section configured to receive identification information for identifying a first terminal from another base station apparatus, the identification information being acquired by the another base station apparatus;
an identification information management section configured to add and manage the received identification information together with an effective period and to delete the identification information under management when the effective period expires;
a receiving section configured to receive a message transmitted from a second terminal; and
an identification information storage section configured to store the identification information corresponding to change contents indicating addition or deletion of the identification information according to the change contents, to compare the stored identification information and identification information included in the message received from the second terminal, to allow access from the second terminal when the comparison result indicates that the stored identification information matches the identification information included in the message received from the second terminal and to reject access from the second terminal when the comparison result indicates that the stored identification information does not match the identification information included in the message received from the second terminal.

9. The base station apparatus according to claim 8, wherein, the identification information management section is configured to, when the received identification information is already under management, delete the identification information under management.

10. The base station apparatus according to claim 9, wherein, the identification information storage section is configured to, when the identification information management section deletes the identification information under the management, delete the identification information identical to the deleted identification information.

11. The base station apparatus according to claim 10, wherein, the identification information storage section is configured to, when identification information of a connected terminal is deleted, issue an instruction to release connection of the terminal.
